(19) United States
(12) Patent Application Publication
(10) Pub. No.: US 2012/0064337 A1
(43) Pub. Date: Mar. 15, 2012

(54) PEELABLE MULTILAYER SURFACE PROTECTING FILM AND PRODUCT

(75) Inventor: Shijie Ren, Shanghai (CN)

(73) Assignee: E. I. DU PONT DE NEMOURS AND COMPANY, Wilmington, DE (US)

(21) Appl. No.: 13/319,609

(22) PCT Filed: May 20, 2010
(86) PCT No.: PCT/US2010/035593

§ 371 Date: Nov. 9, 2011

(30) Foreign Application Priority Data
May 20, 2009 (CN) 200910145422.7

(51) Int. Cl. B32B 7/12

(52) U.S. Cl. 428/349

(57) ABSTRACT

A peelable surface protecting film comprises a polymeric base layer and a layer of heat-activable adhesive composition. The adhesive composition comprises: (a) an ethylene-vinyl acetate copolymer having a content of the moiety derived from vinyl acetate monomer of more than 15 wt % or an ethylene-C₁₋₄ alkyl (meth)acrylate copolymer; (b) an unsaturated dicarboxylic anhydride moiety-containing ethylene-vinyl acetate copolymer or an unsaturated dicarboxylic anhydride moiety-containing ethylene-C₁₋₄ alkyl (meth)acrylate copolymer; (c) 3-35 wt % of a tackifier; and (d) 4.5-30 wt % of a modifier selected from the group consisting of ethylene homopolymer. ethylene-α-olefin copolymer, propylene homopolymer, propylene copolymer, ethylene-vinyl acetate copolymer having a content of the moiety derived from vinyl acetate monomer of less than 15 wt % and a mixture of two or more thereof. Also disclosed is an article protected by the protecting film.

The present invention relates to a peelable multilayer surface protecting film; and this surface protecting film can be used for protection of the surfaces of building and decoration materials, automobiles, and electric home appliances, etc.

### DESCRIPTION OF THE RELATED ART

Metal plates (such as color coated steel plate, stainless steel plate, aluminum plate, etc.), panels of polymer materials, glass, etc., after various kinds of surface treatments (such as surface polishing, coating, painting, and microetching treatment, etc.) can serve as building and decoration materials, automobile panels, electric home appliance panels, etc. To keep them from damage, contamination and/or corrosion in the process of shipping and installation, normally their surface is protected using a surface protecting film. It is desired that this surface protecting film can be easily applied to the surface with a certain viscosity and maintain the adhesive state until it is peeled, and when it is peeled, not only there desirably is no residual remaining on the surface protected, but it is also desirable that the peeling force applied may not be too high, lest causing difficulty to peel.

The peeling strength of the protecting film is affected by the conditions where the protected product is placed (such as temperature, humidity, climate factors, etc.) and by the time of removing adhesion of the protecting film on the protected product. Within this period from the time the protecting film is applied to the time the protecting film is removed, the peeling strength of the protecting film may change, such as an increase or decrease of the peeling strength. Although for some specific uses, the peeling strength of the protecting film when it is being peeled off can be controlled through the initial peeling strength. For a great majority of the uses, increase or decrease of the peeling strength may generate unwanted performance. Therefore, it is desirable that the peeling strength of a protecting film remains stable within a rather long period of time and in various kinds of environmental conditions.

US patent application US2008/0138558A1 discloses a peelable protecting film, which comprises layer of thermoplastic resin structural layer and a heat-activable adhesive composition wherein the adhesive composition comprises an ethylene-vinyl acetate copolymer or ethylene-C₁₋₄ alkyl (meth)acrylate copolymer; an unsaturated dicarboxylic anhydride moiety-containing ethylene-vinyl acetate copolymer or an unsaturated dicarboxylic anhydride moiety-containing ethylene-C₁₋₄ alkyl (meth)acrylate copolymer; and a tackifier.

This protecting film can have a relatively stable peeling strength in many cases. However, it is still desirable to provide a peelable surface protecting film with even more stable peeling strength. It is also desirable to provide a protecting product formed by the protecting film mentioned above.

### SUMMARY OF THE INVENTION

A peelable surface protecting film with a stable peeling strength, which comprises or is produced from a polymeric base layer having laminated, coated, or applied, thereon a layer of heat-activable adhesive composition wherein

the adhesive composition comprises or is produced from (a) an ethylene-vinyl acetate copolymer having a content of the moiety derived from vinyl acetate monomer of more than 15 wt % or an ethylene-C₁₋₄ alkyl (meth)acrylate copolymer; (b) an unsaturated dicarboxylic anhydride moiety-containing ethylene-vinyl acetate copolymer or an unsaturated dicarboxylic anhydride moiety-containing ethylene-C₁₋₄ alkyl (meth)acrylate copolymer; (c) 3-35 wt % of a tackifier; and (d) 4.5-30 wt % of a modifier, which is a polymer selected from the group consisting of ethylene homopolymer, ethylene-α-olefin copolymer, propylene homopolymer, propylene copolymer, ethylene-vinyl acetate copolymer having a content of the moiety derived from vinyl acetate monomer of less than 15 wt % and a mixture of two or more thereof; all % is based on the weight of the adhesive composition;

the total amount of (a) and (b) is 45-92% of the total weight of the composition, and the amount the moiety derived from the anhydride is 0.02-2%; and

the contents of —C(O)O— moiety in (a) and (b) is 7-15% of the total weight of (a) and (b).

Also provided is a product, which comprises or is produced from a substrate and the peelable protecting film as described above.

### DETAILED DESCRIPTION OF THE PREFERRED EMBODIMENT

Unless it is specified otherwise, all of the percentage, portions, and proportions in the present description are based on weight. The term “copolymer” refers to a polymer containing two or more moieties (that is, containing moieties consisting of two or more comonomers). The term “(meth)acrylic acid” refers to acrylic acid or methacrylic acid and the term “(meth)acrylate” refers to acrylate or methacrylate. The term “panel” refers to a product with a primary surface covering a relatively large area and with a relatively thin cross section. The term “C(O)O” indicates carboxylate or caraboxylic, which is such a moiety that it comprises a carbon atom, an oxygen atom that links with the double bond of the carbon atom and an oxygen atom that links with the single bond of the carbon atom, while the other bond of the carbon atom links with a hydrogen atom or with another carbon atom, preferably with another carbon atom. The moiety sometimes is also indicated with “CO₂” or “COO”.

The thermoplastic composition is a polymer material that can flow under the pressure after it is heated.

The melt flow rate (MI) is the flow of a polymer that flows through the set capillary under the conditions of controlled temperature and pressure. Except for polypropylene, the melt flow rate mentioned in the present article is determined using a load of 2160 g according to ASTM 1238 at 190° C., and its unit is “g/10 minutes”. The melt flow rate of polypropylene is determined using a load of 2160 g according to ASTM 1238 at 230° C., and its unit is “g/10 minutes”.

The heat-activable adhesive composition may be softened when it is heated, and adhere to the substrate and is cured to maintain the adhesive state. Unlike the pressure sensitive adhesive that maintains adhesive at ambient temperature, the heat-activable adhesive, unless it is heated, is of low viscosity. The heat-activable adhesive composition described in the present article and the protecting film that contains the adhesive composition can be applied at a relatively low temperature (40-65° C. preferably 50-60° C.). In addition to low cost and being peelable from the surface of the product protected without leaving any residue, this protecting film also provides a peeling strength that remains stable for a long time.

### Polymeric Base Layer

There is no particular restriction to the polymeric base layer applicable to the protecting film described as long as there is enough viscosity between the polymeric base layer and the heat-activable adhesive composition described, so that the protecting film can be peeled off neatly from the surface of the product or panel protected. The polymeric base layer described can be a single thermoplastic polymer resin layer or overlap of two or more thermoplastic polymer resin layers.

As the base [matrix] of the protecting film, the polymeric base layer preferably has sufficient strength and/or thickness to prevent penetration or corrosion, and to protect the surface of the product or panel from any damage. Normally, the protecting film may be placed outdoor together with the product or panel to be protected for 1-2 months or so. Therefore, the polymeric base layer can optionally contain a UV light stabilizing agent component (such as carbon black) to protect the base layer from the impact of UV light.

Non-restrictive examples of polymer resins for making the polymeric base layer described include, such as low density, medium density or high density ethylene homopolymer or copolymer, propylene homopolymer or copolymer, polyester, polyamide, polyvinyl chloride, polycarbonate and a mixture of two or more thereof. It is preferably a polyethylene or polypropylene resin, and most preferably a polyethylene resin, such as a linear low density polyethylene (LLDPE) or a mixture of a low density polyethylene and linear low density polyethylene.

Polymer materials that can serve as the polymeric base layer described also include other common materials in the present field, such as the polymer material mentioned as a substrate in the Japanese patents JP3637940B2 and JP 62001668B (both are quoted in the present article as part of the present article).

### A Heat-Activable Adhesive Composition Layer

Applied to the polymeric base layer is a layer of heat-activable adhesive composition, so that it is capable of adhering to the surface of the product or panel to be protected and can easily be peeled off from the surface of the product or panel to be protected without leaving any residue.

Peeling strength is the measurement of the amount of the force required to remove the protecting film from the surface of the product or panel to be protected. To peel off the protecting film from the surface of the product or panel to be protected under the pressure from different peeling angles and at different speeds, what is desirable is that the bond between the protecting film and the product to be protected is one between interfaces. Interfacial bond is designed in such a way that there may be interfacial debonding between the surface of the adhesive and the product to be protected (that is, the adhesive layer is neatly peeled off from the surface of the product to be protected). If the adhesive cannot be neatly peeled off, the remaining adhesive moiety may contaminate the surface of the product or panel to be protected or contaminate the protecting film itself This kind of contamination can be prevented with interfacially peelable bond.

Besides, as discussed above, the product protected using the protecting film described may be placed outdoor for around 1-2 months. It needs to prevent rise of the peeling strength of the adhesive during this period of time. Rise of the peeling strength may make it difficult for the protecting film to be neatly peeled off from the surface of the product or panel to be protected, thus increasing the possibility of contaminating the surface to be protected.

In most cases, peeling strength is subject to the impact of temperature, pressure, and retention time. For the protecting film described, the adhesive composition is designed in such a way that it is capable of strongly adhering to the polymeric base layer, have an interfacial bond with the surface of the product or panel to be protected, and keeping the peeling strength stable during the entire retention time.

The adhesive composition described in the present invention is heat-activable, and it is applicable at a relatively low temperature (such as 40-65° C., preferably 50-60° C.) to the surface of the product to be protected. The peeling strength formed between the adhesive and the product to be protected is desirably high enough to withstand operation, further processing, shipping, and storage, but low enough so that the protecting film can be removed manually from the product to be protected in a relatively easy way. Preferably, the peeling strength between the adhesive described and the surface of the product to be protected is 0.25-8.0 N/25 mm, more preferably 0.4-5.5 N/25 mm, and most preferably 0.8 N-4.5 N/25 mm

Although it is desirable that the adhesive described can be easily peeled off from the product to be protected, it is also desirable that the adhesive is capable of irreversible or strong adherence to the polymeric base layer, so that it can maintain structural integrity of the adhesive layer in the entire process of protecting the surface of the product or panel to be protected or when the protecting film is peeled off from the surface of the product or panel to be protected.

In the present article, the term “irreversible adhesion” means that the neighboring polymeric base layer and the adhesive layer cannot be separated manually and unless one or two layers of the neighboring polymeric base layer and adhesive layer is damaged, the two layers cannot be separated. Preferably, the peeling strength between the adhesive layer and polymeric base layer described is over 10.0 N/25 mm or so, and more preferably it is over 20.0 N/25 mm or so.

In order to provide proper viscosity, certain degrees of polarity of the adhesive composition described are desired or preferred. The degree of polarity depends on the amount of the polar comonomer in the composition. The vinyl acetate and (meth) ethylene-alkyl (meth)acrylate comonomer mainly provides the C(C═O)O moiety for the adhesive composition. As discussed above, the amount of the C(C═O)O makes up 7-15% by weight of the total weight of (a) and (b) in the adhesive composition.

In order to improve the long-term stability of the peeling strength of the adhesive composition described, the adhesive composition also comprises a modifier that makes up 4.5-30% of the total weight of the composition. After the modifier described is added in, the adhesive composition of the present invention can further improve the long-term stability of the peeling strength on the basis of maintaining the original peeling strength.

The following is a further detailed description of the various components of the adhesive composition described.

### Ethylene-Vinyl Acetate Copolymer Having a Content of Vinyl Acetate of More Than 15%

The adhesive composition described may comprise at least an ethylene-vinyl acetate copolymer with a content of vinyl acetate of more than 15%, the ethylene-vinyl acetate copolymer described comprises a copolymer consisting of ethylene and vinyl acetate through copolymerization, and also of a copolymer consisting of ethylene, vinyl acetate, and other comonomers through copolymerization.

In the ethylene-vinyl acetate copolymer described, the content of vinyl acetate is more than 15 wt %, such as 15-45 wt %, preferably 18-40 wt %, and most preferably 20-35 wt %.

The melting point of the ethylene-vinyl acetate copolymer is preferably lower than 90° C., more preferably lower than 85° C., and most preferably lower than 80° C.; and it depends on the content of vinyl acetate. For example, the melting point of the ethylene-vinyl acetate copolymer is lower than 90° C. when the content of vinyl acetate is more than 15 wt %, the melting point of the ethylene-vinyl acetate copolymer is lower than 85° C. when the content of vinyl acetate is more than 18 wt %, and the melting point of the ethylene-vinyl acetate copolymer is lower than 80° C. when the content of vinyl acetate is more than 23 wt %.

It is determined according to ASTM D 1238 at 190° C. that the melt flow rate of the ethylene-vinyl acetate copolymer is 0.5-30 g/10 min, preferably 1-25 g/10 min, and most preferably 2-15 g/10 min.

An applicable ethylene-vinyl acetate copolymer is available in the market for purchase, for example, it can be purchased from E. I. du Pont de Nemours and Company (DuPont) of the United States.

A mixture of two or more of the ethylene-vinyl acetate copolymers with the content of vinyl acetate of more than 15% can be used in place of a single ethylene-vinyl acetate with the content of vinyl acetate of more than 15% to make adjustment for the properties desired, as far as the C(C═O)O total amount of components (a) and (b) mentioned above is met.

### Ethylene-C₁₋₄ Alkyl (Meth)Acrylate Copolymer

The adhesive composition may comprise at least an ethylene-C₁₋₄ alkyl (meth)acrylate copolymer such as methyl acrylate and methyl methacrylate, ethyl acrylate or ethyl methacrylate, propyl acrylate or propyl methacrylate or butyl acrylate or butyl methacrylate.

The content of C₁₋₄ alkyl (meth)acrylate in the ethylene C₁₋₄ alkyl (meth)acrylate copolymer can be as high as 40 wt %, preferably 5-35 wt %, and most preferably 8-25 wt %.

The melting point of the ethylene C₁₋₄ alkyl (meth)acrylate copolymer is lower than 95° C., preferably lower than 85° C., and it is determined according to ASTM D 1238 at 190° C. that the melt flow rate of the ethylene-vinyl acetate copolymer is 0.5-30 g/10 min, preferably 1-25 g/10 min, and most preferably 2-15 g/10 min.

The ethylene-C₁₋₄ alkyl (meth)acrylate copolymer described is available in the market for purchase, such as the products of ethylene-C₁₋₄ alkyl (meth)acrylate copolymer of various brands purchased from DuPont.

A mixture of two or more of ethylene-C₁₋₄ alkyl (meth)acrylate copolymers can be used, as far as the C(C═O)O total amount of components (a) and (b) mentioned above are met.

### An Ethylene Copolymer Modified With Anhydride

The modified ethylene copolymer used as component (b) in the adhesive composition described comprises an ethylene copolymer that contains unsaturated dicarboxylic anhydride moiety, and this modified ethylene copolymer is preferably formed with 0.1-3 wt % of an anhydride moiety grafted to the ethylene-vinyl acetate copolymer or ethylene C₁₋₄ alkyl (meth)acrylate copolymer. Monomers that can form the unsaturated dicaroxylic anhydride moiety described include maleic anhydride, citric anhydride, itaconic anhydride, tetra hydro phthalic anhydride, etc. It is preferably maleic anhydride. The anhydride described provides such an active functional group that it can promote bonding between the adhesive composition and the surface of the substrate to be protected. As discussed above, the quantity of the anhydride moiety described may make up 0.02-2 wt % of the total weight of the adhesive composition, preferably 0.05-1.8 wt %, and more preferably 0.08-1.5 wt %.

The modified ethylene copolymer described can be prepared using any known methods in the present field, such as one wherein the ethylene-vinyl acetate copolymer or the ethylene-C₁₋₄ alkyl (meth)acrylate is dissolved in a solvent added with unsaturated dicarboxylic anhydride (such as maleic anhydride) and free radical-producing radical, then heated with agitation. Another way is to add all components to an extruder to form ethylene copolymer grafted with unsaturated dicarboxylic anhydride.

The ethylene-vinyl acetate copolymer applicable for grafting with anhydride can be the same as the ethylene-vinyl acetate copolymer mentioned above. In principle, the relative quantity of the vinyl acetate monomer in the copolymer can make up 7-45 wt % of the total quantity of the copolymer before grafting. When component (a) is ethylene-vinyl acetate, preferably the component (b) is an ethylene-vinyl acetate copolymer grafted with anhydride. Besides, preferably ethylene-vinyl acetate with the same properties as ethylene-vinyl acetate in component (a) is used for modification to form component (b) after grafting with unsaturated dicarboxylic anhydride. In an example of the present invention, an ethylene-vinyl acetate copolymer with its content of vinyl acetate being 20-40 wt %, preferably 25-28 wt % is modified using maleic anhydride, so that the amount of the moiety from maleic anhydride makes up over 1 wt % of the total quantity of the grated copolymer.

The ethylene-C₁₋₄ alkyl (meth)acrylate applicable for grafting with anhydride can be the same as the ethylene-C₁₋₄ alkyl (meth)acrylate mentioned above. When component (a) is ethylene-C₁₋₄ alkyl (meth)acrylate, preferably the component (b) is an ethylene-C₁₋₄ alkyl (meth)acrylate modified with anhydride. More preferably, ethylene-C₁₋₄ alkyl (meth)acrylate with the same properties as ethylene-C₁₋₄ alkyl (meth)acrylate in component (a) is used for modification with unsaturated dicarboxylic anhydride to form component (b).

These grafted copolymers are also available in the market for purchase. For example, it can be purchased from DuPont.

### The Tackifier

The tackifier is mainly used to enhance the initial viscosity of the adhesive to the surface of different substrates. The tackifier enhances the tackiness of the adhesive, reduces its viscosity, and may reduce its deformation resistance, and helps to form bonding through contact.

The tackifier described can be any tackifier known in the present field. Exemplified is the tackifier described in U.S. Pat. No. 3,484,405 (the literature is quoted in the present article as part of the present invention). This tackifier comprises various kinds of natural or synthetic resin or rosin materials. Applicable resin can be in a liquid, semi-solid to solid mixed amorphous material (normally a mixture of organic compounds without any set melting point and not crystallized). This resin is insoluble in water, and may be derived from animals or plants or may be synthetic resin. With this resin, the adhesive composition can have a significant and modified viscosity.

Unrestricted examples of appropriate tackifiers include, for example, coumarone-indene resin with a molecular weight of 500-5000, such as p-coumarone resin; terpene resin with a molecular weight of 600-6000; butadiene-styrene resin with a molecular weight of 500-5000; and polybutadiene resin with a molecular weight of 500-5000. And these tackifiers are available in the market for purchase in the product name of BUTON.

Tackifiers applicable to the adhesive composition described also comprise tackifiers of hydrocarbons. This tackifier normally is prepared from the fraction obtained from petroleum refining through catalytic polymerization, and its molecular weight is normally 500-5000. Hydrocarbon tackifiers are available in the market for purchase, such as those with brand names of PICCOPALE-100, AMOCO, and VESICOL. Applicable tackifiers also comprise polybutylene prepared from isobutylene through polymerization, and hydrocarbon resin known as REGALITE available for purchase from Eastman Chemical Company.

Calculated by the total weight of the adhesive composition, the content of the tackifier described is 3-35 wt %, preferably 3.5-30 wt %, and more preferably 3.7-20 wt %.

### Modifier

In order to improve the stability of the peelable protecting film described (that is, the long-term stability of the peeling strength), the composition described also comprises a modifier. The modifier described is selected from the group consisting of ethylene homopolymer, ethylene copolymer, propylene homopolymer, propylene copolymer, ethylene-vinyl acetate copolymer with the content of vinyl acetate ranging from 1-15 wt % or a mixture of two or more thereof.

An applicable ethylene homopolymer can be a linear polymer, such as high density polyethylene (HDPE), linear low density polyethylene (LLDPE), ultra low density polyethylene (ULDPE), and it can also be branched polyethylene, such as low density polyethylene (LDPE). The density of an applicable polyethylene is normally 0.865-0.970 g/cc.

Another way is to mix an a-olefin comonomer (such as butene, hexene, or octene) to the polymer described to form an ethylene polymer, and the density of the polymer is within the range of the density mentioned above. Therefore, “polyethylene” used in the present article covers the ethylene homopolymer and ethylene copolymer mentioned above.

The melt flow rate of the polyethylene described (determined according to ASTM D 1238 at 190° C.) is 0.5-15 g/10 min, preferably 1-13 g/[10] min, more preferably 2-10 g/10 min

Propylene homopolymers, random copolymers and/or block copolymers of propylene (hereafter polypropylene in general), too, can be used as modifiers in the composition described. A propylene copolymer comprises a unit from propylene that serves as the primary monomeric unit and monomeric units from other olefins (such as at least a unit selected from the group consisting of ethylene, 1-butene, 2-butene, amylene and various derivatives of amylene). A preferred propylene copolymer is the copolymer of propylene and ethylene.

The melt flow rate of the polypropylene described (determined according to ASTM D 1238 at 230° C.) is 0.5-15 g/10 min, preferably 1-13 g/10 min, and most preferably 2-10 g/10 min.

An ethylene/vinyl acetate copolymer that can be used as a modifier is an ethylene-vinyl acetate copolymer with its content of vinyl acetate lower than 15%. The content of vinyl acetate in the copolymer is preferably 1-15 wt %, more preferably 2-12 wt %, and most preferably 3-10 wt %.

The melt flow rate of the ethylene-vinyl acetate copolymer described (determined according to ASTM D 1238 at 190° C.) is 0.5-15 g/10 min, preferably 1-13 g/10 min, and most preferably 2-10 g/10 min

Calculated by the total weight of the adhesive composition, the addition of the modifier described is 4.5-30 wt %, preferably 7-28 wt %, more preferably 10-25 wt %, and most preferably 15-20 wt %.

In the adhesive composition described, calculated by the total weight of the composition, the total of components (a) and (b) makes up 45-92 wt %, preferably 50-85 wt %, and more preferably 55-80 wt %.

In the adhesive composition described, calculated by the total weight of the composition, the total of the polymeric moiety derived from anhydride makes up 0.02-2 wt %, preferably 0.05-1.8 wt %, and more preferably 0.08-1.5 wt %, of the total weight of the composition.

In the composition described, the content of the C(C—O)O moiety in components (a) and (b) makes up 7-15 wt %, preferably 8-12 wt %, and more preferably 9-11 wt % of the total weight of components (a) and (b).

In an example, the adhesive composition described comprises 40-70 wt % of a copolymer with an ethylene monomeric unit and a vinyl acetate monomeric unit; 10-25 wt % of a copolymer with an ethylene monomeric unit and a vinyl acetate monomeric unit and grafted using maleic anhydride, wherein the content of the C(C—O)O moiety makes up 9-15 wt % of the total weight of the components mentioned above, and maleic anhydride makes up 0.1-1 wt % of the total weight of the composition; the adhesive composition described also comprises 3.5-1.6 wt % of the tackifier and 7-25 wt % of the modifier.

Based on need, the adhesive composition described may also comprise any other appropriate additives, such as UV absorbent, viscosity stabilizer, UV stabilizer, hydrolysis stabilizer, antioxidant, antistatic agent, dyestuff, pigment or staining agent (such as titanium dioxide or carbon black), flame retardant, lubricant, defoaming agent, anti-tackiness agent, peeling agent or two or a mixture of two or more thereof.

In the adhesive composition described, the addition of the additives described normally makes up 0.01-15 wt % of the total weight of the composition, more preferably 0.02-10 wt %, and most preferably 0.03-5 wt %, if they do not have any negative impact on the properties desired (particularly the long-term stability of the viscosity and peeling strength).

Any methods known in the present field can be used as the method to prepare the adhesive composition described. For example, the various components after dry mixing can be placed in a double screw extruder for melt mixing. For example, the various components can be placed in a double screw extruder for melt mixing at a melt temperature of 180-230° C.

The melt flow rate of the composition after blending is 0.5-20 g/10 min For good processability, particularly film blowing, the melt flow rate is preferably lower than 15 g/10 min (such as 1-14 g/10 min, preferably 1.5-13 g/10 min), and more preferably lower than 10 g/10 min (such as 1.8-10 g/10 min, preferably 2-8 g/10 min)

There is no special restriction to the method of preparing the peelable surface protecting film described. It can be prepared using various methods and technologies and applying the composition mentioned above. For example, the adhesive composition can be made into a thin film using the doctor-blade casting or blow molding extrusion process, and the adhesive film is then immediately composited to the polymer substrate. Or, the adhesive composition and the thermoplastic polymer that serves as the polymer substrate can be extruded together using the film casting or blow molding process to form the protecting film.

In an example, the adhesive composition is directly extruded together with the polymer substrate using a method known in the present field. The thickness of the polymer substrate described is 10-500μ, and preferably 20-300μ.

When it is used, the described peelable surface protecting film prepared above is, for example, applied by means of hot joint to the surface of the product to be protected to form the external surface of the product to be protected, so as to keep the surface of the product to be protected from any damage, coat flaking off, contamination, corrosion, etc., during shipping, storage, or molding. The product described can be, for example, a color coated steel plate, stainless steel plate, aluminum plate, copper plate, etc. The hot joint described can be implemented using a roller or rolling machine at a temperature around 40-65° C., preferably 50-60° C.

The protecting film described is mainly for protecting metal products, but the film can also be used to protect synthetic resin products. Examples of synthetic resin products described include, such as methyl acrylate resin, polycarbonate resin, etc. The protecting film described in the present article can also be used to protect surfaces of treated wood, wood composite, glass, and paper.

The following is a further description with reference to examples.

### Comparative Example 1

Described in the present comparative example is the change of the peeling strength of the adhesive composition over time under aging at high temperature when no modifier is used.

In a 20-mm Brabender double screw extruder, melts of 4.11 kg of an ethylene-vinyl acetate copolymer (25 wt % of vinyl acetate, melt flow rate being 2.0 g/10 min, and melting point around 77° C.), 3.23 kg of an ethylene-vinyl acetate copolymer (28 wt % of vinyl acetate, melt flow rate being 6.0 g/10 min, and melting point around 69° C.), and 2 kg of a maleic acid grafted ethylene-vinyl acetate copolymer (28 wt % of vinyl acetate, melt flow rate being 1.4 g/10 min), 500 g of the hydrogenated hydrocarbon resin tackifies (REGALITE® 1125, purchased from Eastman Chemical Company) and 10 g of the antioxidant (commercial name Anox™ 20N purchased from Chemtura) were mixed. The screw of the extruder was set in such a way that all of the components can be melted/kneaded, and appropriately dispersed. The temperature of the processing area was set at 130-190° C., and the melt temperature at 205-210° C. The screw speed was 190 rpm. The feed speed was set at 6 kg/hr. After that, the composition was dried in an air oven of 40° C. for 10 hours to remove the excessive moisture.

A mixture of 70 portions of linear low density polyethylene (LLDPE, with the melting flow rate being 2 g/10 min, purchased from ExxonMobil Chemical with the commercial name of LL1002YB) and 30 portions of high density polyethylene (HDPE, with the melting flow rate being 0.7 g/min, from ExxonMobil Chemical with the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min The film formed had the following structure (total thickness 50μ):
20μ (70% LLDPE+30% HDPE)−20μ (70% LLDPE+30% LDPE)−10μ adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, with the cross head speed being set at 300 mm/min, and 180° as the peeling angle. The peeling strength at different aging times (the mean value of 5 tests) and the appearance of the surface protected were recorded. The results are listed in the table below:

| Storage | Storage Temp | Peel strength | Appearance of the |
|---|---|---|---|
| Days | (° C.) | (N/25 mm) | surface after peeling |
| 1 | 23 | 2.5 | No residue |
| 1 | 60 | 8.9 | No residue |
| 3 | 60 | 13.5 | No residue |
| 5 | 60 | 13.7 | No residue |

Test results indicate that the peeling strength after it was stored at room temperature for 1 day was 2.5 N/25 mm, while the peeling strength after aging at high temperature increased to 13.7 N/25 mm, which greatly exceeds the desired peeling strength (0.25-8 N/25 mm)

### Example 1

### Described in the Present Example is the Impact of Addition of Low Density Polyethylene on the Stability of the Final Peeling Strength After Aging

In a 20-mm Brabender double screw extruder, melts of 4.11 kg of an ethylene-vinyl acetate copolymer (25 wt % of vinyl acetate, melt flow rate being 2.0 g/10 min, and melting point around 77° C.), 3.23 kg of an ethylene-vinyl acetate copolymer (28 wt % of vinyl acetate, melt flow rate being 6.0 g/10 min, and melting point around 69° C.), and 2 kg of a maleic acid grafted ethylene-vinyl acetate copolymer (28 wt % of vinyl acetate, melt flow rate being 1.4 g/10 min), 500 g of the hydrogenated hydrocarbon resin tackifies (REGALITE® 1125, purchased from Eastman Chemical Company) and 10 g of the antioxidant (commercial name Anox™ 20N purchased from Chemtura) and 3.3 kg of low density polyethylene (0.923 in density, and melt flow rate being 2.0 g/10 min) were mixed. The screw of the extruder was set in such a way that all of the components can be melted/kneaded, and appropriately dispersed. The temperature of the processing area was set at 130-190° C., and the melt temperature at 205-210° C. The screw speed was 190 rpm. The feed speed was set at 6 kg/hr. After that, the composition was dried in an air oven of 40° C. for 10 hours to remove the excessive moisture.

A mixture of 70 portions of linear low density polyethylene (LLDPE, the melting flow rate being 2 g/10 min, purchased from ExxonMobil Chemical with the commercial name of LL1002YB) and 30 portions of high density polyethylene (HDPE, the melting flow rate being 0.7 g/min, from ExxonMobil Chemical with the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min. The film formed had the following structure (total thickness 50μ):
20μ (70% LLDPE+30% HDPE)−20μ (70% LLDPE+30% LDPE)−10μ adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, with the cross head speed being set at 300 mm/min, and 180° as the peeling angle. The peeling strength at different aging times (the mean value of 5 tests) and the appearance of the surface protected were recorded. The results are listed in the table below:

| Storage | Storage Temp | Peel Strength | Appearance of the |
|---|---|---|---|
| Days | (° C.) | (N/25 mm) | surface after peeling |
| 1 | 23 | 1.6 | No residue |
| 1 | 60 | 4.0 | No residue |
| 3 | 60 | 4.7 | No residue |
| 5 | 60 | 5.0 | No residue |

Test results indicated that after 25% low density polyethylene was added in, the peeling strength after it was stored at room temperature for 1 day was 1.6 N/25 mm, while the peeling strength after aging at high temperature increased to 5.0 N/25 mm, both of which can meet the peeling strength (0.25-8.0 N/25 mm)

### Example 2

### Described in the Present Example is the Impact of Addition of Low Density Polyethylene on the Stability of the Final Peeling Strength After Aging

In a 20-mm Brabender double screw extruder, melts of 4.11 kg of an ethylene-vinyl acetate copolymer (25 wt % of vinyl acetate, melt flow rate being 2.0 g/10 min, and melting point around 77° C.), 3.23 kg of an ethylene-vinyl acetate copolymer (28 wt % of vinyl acetate, melt flow rate being 6.0 g/10 min, and melting point around 69° C.), and 2 kg of a maleic acid grafted ethylene-vinyl acetate copolymer (28 wt % of vinyl acetate, melt flow rate being 1.4 g/10 min), 500 g of the hydrogenated hydrocarbon resin tackifies (REGALITE® 1125, purchased from Eastman Chemical Company) and 10 g of the antioxidant (commercial name Anox™ 20N purchased from Chemtura) and 1.1 kg of low density polyethylene (0.923 in density, and melt flow rate being 2.0 g/10 min) were mixed. The screw of the extruder was set in such a way that all of the components can be melted/kneaded, and appropriately dispersed. The temperature of the processing area was set at 130-190° C., and the melt temperature at 205-210° C. The screw speed was 190 rpm. The feed speed was set at 6 kg/hr. After that, the composition was dried in an air oven of 40° C. for 10 hours to remove the excessive moisture.

A mixture of 70 portions of linear low density polyethylene (LLDPE, the melting flow rate being 2 g/10 min, purchased from ExxonMobil Chemical with the commercial name of LL1002YB) and 30 portions of high density polyethylene (HDPE, the melting flow rate being 0.7 g/min, from ExxonMobil Chemical with the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min. The film formed had the following structure (total thickness 50μ):
20μ (70% LLDPE+30% HDPE)−20μ (70% LLDPE+30% LDPE)−10μ adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, with the cross head speed was set at 300 mm/min, and 180° as the peeling angle. The peeling strength at different aging times (the mean value of 5 tests) and the appearance of the surface protected were recorded. The results are listed in the table below:

| Storage | Storage Temp | Peel Strength | Appearance of the |
|---|---|---|---|
| Days | (° C.) | (N/25 mm) | surface after peeling |
| 1 | 23 | 2.1 | No residue |
| 1 | 60 | 5.8 | No residue |
| 3 | 60 | 7.2 | No residue |
| 5 | 60 | 7.7 | No residue |

Test results indicated that after 10% low density polyethylene was added in, the peeling strength after it was stored at room temperature for 1 day was 2.1 N/25 mm, while the peeling strength after aging at high temperature increased to 7.7 N/25 mm, both of which can basically meet the peeling strength (0.25-8.0 N/25 mm)

### Example 3

### Described in the Present Example is the Impact of Addition of Linear Low Density Polyethylene on the Stability of the Final Peeling Strength After Aging

In a 20-mm Brabender double screw extruder, melts of 4.11 kg of an ethylene-vinyl acetate copolymer (25 wt % of vinyl acetate, melt flow rate being 2.0 g/10 min, and melting point around 77° C.), 3.23 kg of an ethylene-vinyl acetate copolymer (28 wt % of vinyl acetate, melt flow rate being 6.0 g/10 min, and melting point around 69° C.), and 2 kg of a maleic acid grafted ethylene-vinyl acetate copolymer (28 wt% of vinyl acetate, melt flow rate being 1.4 g/10 min), 500 g of the hydrogenated hydrocarbon resin tackifies (REGALITE® 1125, purchased from Eastman Chemical Company) and 10 g of the antioxidant (commercial name Anox™ 20N purchased from Chemtura) and 3.3 kg of linear low density polyethylene (0.918 in density, and melt flow rate being 2.0 g/10 min) were mixed. The screw of the extruder was set in such a way that all of the components can be melted/kneaded, and appropriately dispersed. The temperature of the processing area was set at 130-190° C., and the melt temperature at 205-210° C. The screw speed was 190 rpm. The feed speed was set at 6 kg/hr. After that, the composition was dried in an air oven of 40° C. for 10 hours to remove the excessive moisture.

A mixture of 70 portions of linear low density polyethylene (LLDPE, the melting flow rate being 2 g/10 min, purchased from ExxonMobil Chemical with the commercial name of LL1002YB) and 30 portions of high density polyethylene (HDPE, the melting flow rate being 0.7 g/min, from ExxonMobil Chemical with the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min. The film formed had the following structure (total thickness 50μ):
20μ (70% LLDPE+30% HDPE)−20μ (70% LLDPE+30% LDPE)−10μ the adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, with the cross head speed set at 300 mm/min, and 180° as the peeling angle. The peeling strength at different aging times (the mean value of 5 tests) and the appearance of the surface protected were recorded. The results are listed in the table below:

| Storage | Storage Temp | Peel Strength | Appearance of the |
|---|---|---|---|
| Days | (° C.) | (N/25 mm) | surface after peeling |
| 1 | 23 | 1.4 | No residue |
| 1 | 60 | 4.1 | No residue |
| 3 | 60 | 4.6 | No residue |
| 5 | 60 | 5.0 | No residue |

Test results indicated that after 25% linear low density polyethylene was added in, the peeling strength after it was stored at room temperature for 1 day was 1.4 N/25 mm, while the peeling strength after aging at high temperature increased to 5.0 N/25 mm, both of which can basically meet the peeling strength (0.25-8.0 N/25 mm)

### Example 4

### Described in the Present Example is the Impact of Addition of Polypropylene on the Stability of the Final Peeling Strength After Aging

In a 20-mm Brabender double screw extruder, melts of 4.11 kg of an ethylene-vinyl acetate copolymer (25 wt % of vinyl acetate, melt flow rate being 2.0 g/10 min, and melting point around 77° C.), 3.23 kg of an ethylene-vinyl acetate copolymer (28 wt % of vinyl acetate, melt flow rate being 6.0 g/10 min, and melting point around 69° C.), and 2 kg of a maleic acid grafted ethylene-vinyl acetate copolymer (28 wt % of vinyl acetate, melt flow rate being 1.4 g/10 min), 500 g of the hydrogenated hydrocarbon resin tackifies (REGALITE® 1125, purchased from Eastman Chemical Company) and 10 g of the antioxidant (commercial name Anox™ 20N purchased from Chemtura) and 4.2 kg of homopolymeric polypropylene (0.905 in density, and melt flow index [sic] being 3.8 g/10 min) were mixed. The screw of the extruder was set in such a way that all of the components can be melted/kneaded, and appropriately dispersed. The temperature of the processing area was set at 130-190° C., and the melt temperature at 205-210° C. The screw speed was 190 rpm. The feed speed was set at 6 kg/hr. After that, the composition was dried in an air oven of 40° C. for 10 hours to remove the excessive moisture.

A mixture of 70 portions of linear low density polyethylene (LLDPE, the melting flow rate being 2 g/10 min, purchased from ExxonMobil Chemical with the commercial name of LL1002YB) and 30 portions of high density polyethylene (HDPE, the melting flow rate being 0.7 g/min, from ExxonMobil Chemical with the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min. The film formed had the following structure (total thickness 50μ):
20μ (70% LLDPE+30% HDPE)−20μ (70% LLDPE+30% LDPE)−10μ the adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, the cross head speed was set at 300 mm/min, and 180° as the peeling angle. The peeling strength at different aging times (the mean value of 5 tests) and the appearance of the surface protected were recorded. The results are listed in the table below:

| Storage | Storage Temp | Peel strength | Appearance of the |
|---|---|---|---|
| Days | (° C.) | (N/25 mm) | surface after peeling |
| 1 | 23 | 0.9 | No residue |
| 1 | 60 | 3.0 | No residue |
| 3 | 60 | 3.8 | No residue |
| 5 | 60 | 4.1 | No residue |

Test results indicated that after 30% homopolymeric polypropylene was added in, the peeling strength after it was stored at room temperature for 1 day was 0.9 N/25 mm, while the peeling strength after aging at high temperature increased to 4.1 N/25 mm, both of which can basically meet the peeling strength (0.25-8.0 N/25 mm)

### Example 5

### Described in the Present Example is the Impact of Addition of Ethylene-Vinyl Acetate Copolymer With a Content of Vinyl Acetate Lower Than 15 wt % on the Stability of the Final Peeling Strength After Aging

In a 20-mm Brabender double screw extruder, melts of 4.11 kg of an ethylene-vinyl acetate copolymer (25 wt % of vinyl acetate, melt flow rate being 2.0 g/10 min, and melting point around 77° C.), 3.23 kg of an ethylene-vinyl acetate copolymer (28 wt % of vinyl acetate, melt flow rate being 6.0 g/10 min, and melting point around 69° C.), and 2 kg of a maleic acid grafted ethylene-vinyl acetate copolymer (28 wt % of vinyl acetate, melt flow rate being 1.4 g/10 min), 500 g of the hydrogenated hydrocarbon resin tackifies (REGALITE® 1125, purchased from Eastman Chemical Company) and 10 g of the antioxidant (commercial name Anox™ 20N purchased from Chemtura) and 2.46 kg of ethylene-vinyl acetate (the content of vinyl acetate being 12%, and melt flow rate being 2.5 g/10 min) were mixed. The screw of the extruder was set in such a way that all of the components can be melted/kneaded, and appropriately dispersed. The temperature of the processing area was set at 130-190° C., and the melt temperature at 205-210° C. The screw speed was 190 rpm. The feed speed was set at 6 kg/hr. After that, the composition was dried in an air oven of 40° C. for 10 hours to remove the excessive moisture.

A mixture of 70 portions of linear low density polyethylene (LLDPE, the melting flow rate being 2 g/10 min, purchased from ExxonMobil Chemical with the commercial name of LL1002YB) and 30 portions of high density polyethylene (HDPE, the melting flow rate being 0.7 g/min, from ExxonMobil Chemical with the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min. The film formed had the following structure (total thickness 50μ):
20μ (70% LLDPE+30% HDPE)−20μ (70% LLDPE+30% LDPE)−10μ the adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, with the cross head speed being set at 300 mm/min, and 180° as the peeling angle. The peeling strength at different aging times (the mean value of 5 tests) and the appearance of the surface protected were recorded. The results are listed in the table below:

| Storage | Storage Temp | Peel strength | Appearance of the |
|---|---|---|---|
| Days | (° C.) | (N/25 mm) | surface after peeling |
| 1 | 23 | 2.3 | No residue |
| 1 | 60 | 6.4 | No residue |
| 3 | 60 | 7.5 | No residue |
| 5 | 60 | 7.9 | No residue |

Test results indicated that after 20% ethylene-vinyl acetate copolymer with the content of vinyl acetate being 12% was added in, the peeling strength after it was stored at room temperature for 1 day was 2.3 N/25 mm, while the peeling strength after aging at high temperature increased to 7.9 N/25 mm, both of which can basically meet the peeling strength (0.25-8.0 N/25 mm)

### Comparative Example 2

### Described in the Present Comparative Example is the Change of the Peeling Strength of the Adhesive Composition Over Time Under Aging at High Temperature When No Modifier is Used.

In a 20-mm Brabender double screw extruder, melts of 5.99 kg of an ethylene-vinyl acetate copolymer (25 wt % of vinyl acetate, melt flow rate being 2.0 g/10 min), 3.0 kg of a maleic acid grafted ethylene-vinyl acetate copolymer (28 wt % of vinyl acetate, melt flow rate being 1.4 g/10 min), 1.0 kg g of the hydrogenated hydrocarbon resin tackifier (REGALITE® 1125, purchased from Eastman Chemical Company) and 10 g of the antioxidant (commercial name Anox™ 20N purchased from Chemtura) were mixed. The screw of the extruder was set in such a way that all of the components can be melted/kneaded, and appropriately dispersed. The temperature of the processing area was set at 130-190° C., and the melt temperature at 205-210° C. The screw speed was 250 rpm. The feed speed was set at 6 kg/hr. After that, the composition was dried in an air oven of 40° C. for 10 hours to remove the excessive moisture.

A mixture of 70 portions of linear low density polyethylene (LLDPE, the melting flow rate being 2 g/10 min, purchased from ExxonMobil Chemical with the commercial name of LL1002YB) and 30 portions of high density polyethylene (HDPE, the melting flow rate being 0.7 g/min, from ExxonMobil Chemical with the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min. The film formed had the following structure (total thickness 50μ):
20μ (70% LLDPE+30% HDPE)−20μ (70% LLDPE+30% LDPE)−10μ the adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, with the cross head speed being set at 300 mm/min, and 180° as the peeling angle. The peeling strength at different aging times (the mean value of 5 tests) and the appearance of the surface protected were recorded. The results are listed in the table below:

| Storage | Storage Temp | Peel strength | Appearance of the |
|---|---|---|---|
| Days | (° C.) | (N/25 mm) | surface after peeling |
| 1 | 23 | 2.4 | No residue |
| 1 | 60 | 5.0 | No residue |
| 3 | 60 | 8.5 | No residue |
| 5 | 60 | 9.2 | No residue |

Test results indicated that the peeling strength after it was stored at room temperature for 1 day was 2.4 N/25 mm, while the peeling strength after aging at high temperature increased to 9.2 N/25 mm, which greatly exceeds the peeling strength (0.25-8.0 N/25 mm)

### Example 6

### Described in the Present Example is the Impact of Addition of Low Density Polyethylene on the Stability of the Final Peeling Strength After Aging

In a 20-mm Brabender double screw extruder, melts of 5.99 kg of an ethylene-vinyl acetate copolymer (25 wt % of vinyl acetate, melt flow rate being 2.0 g/10 min), 3.0 kg of a maleic acid grafted ethylene-vinyl acetate copolymer (28 wt % of vinyl acetate, melt flow rate being 1.4 g/10 min), 1.0 kg g of the hydrogenated hydrocarbon resin tackifier (REGALITE® 1125, purchased from Eastman Chemical Company) and 10 g of the antioxidant (commercial name Anox™ 20N purchased from Chemtura) and 2.5 kg of low density polyethylene (0.923 in density, melt flow rate being 2.0 g/10 min) were mixed. The screw of the extruder was set in such a way that all of the components can be melted/kneaded, and appropriately dispersed. The temperature of the processing area was set at 130-190° C., and the melt temperature at 205-210° C. The screw speed was 250 rpm. The feed speed was set at 6 kg/hr. After that, the composition was dried in an air oven of 40° C. for 10 hours to remove the excessive moisture.

A mixture of 70 portions of linear low density polyethylene (LLDPE, the melting flow rate being 2 g/10 min, purchased from ExxonMobil Chemical with the commercial name of LL1002YB) and 30 portions of high density polyethylene (HDPE, the melting flow rate being 0.7 g/min, from ExxonMobil Chemical in the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min. The film formed had the following structure (total thickness 50μ):
20μ (70% LLDPE+30% HDPE)−20μ (70% LLDPE+30% LDPE)−10μ the adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, with the cross head speed being set at 300 mm/min, and 180° as the peeling angle. The peeling strength at different aging times (the mean value of 5 tests) and the appearance of the surface protected were recorded. The results are listed in the table below:

| Storage | Storage Temp | Peel strength | Appearance of the |
|---|---|---|---|
| Days | (° C.) | (N/25 mm) | surface after peeling |
| 1 | 23 | 0.7 | No residue |
| 1 | 60 | 1.2 | No residue |
| 3 | 60 | 1.4 | No residue |
| 5 | 60 | 1.5 | No residue |

Test results indicated that after 20% low density polyethylene was added in, the peeling strength after it was stored at room temperature for 1 day was 0.7 N/25 mm, while the peeling strength after aging at high temperature for 5 days was 1.5 N/25 mm, both of which can meet the peeling strength (0.25-8.0 N/25 mm).

### Comparative Example 3

### Described in the Present Comparative Example Was the Change of the Peeling Strength of the Adhesive Composition Over Time Under Aging at High Temperature When No Modifier is Used.

In a 20-mm Brabender double screw extruder, melts of 2.5 kg of an ethylene-vinyl acetate copolymer (25 wt % of vinyl acetate, melt flow rate being 2.0 g/10 min), 2.5 kg of an ethylene-vinyl acetate copolymer (28 wt % of vinyl acetate, melt flow rate being 6.0 g/10 min), and 3.0 kg of a maleic acid grafted ethylene-vinyl acetate copolymer (28 wt % of vinyl acetate, melt flow rate being 1.4 g/10 min), 2.0 kg of the hydrogenated hydrocarbon resin tackifier (REGALITE® 1125, purchased from Eastman Chemical Company) and 10 g of the antioxidant (commercial name Anox™ 20N purchased from Chemtura) were mixed. The screw of the extruder was set in such a way that all of the components can be melted/kneaded, and appropriately dispersed. The temperature of the processing area was set at 130-190° C., and the melt temperature at 205-210° C. The screw speed was 250 rpm. The feed speed was set at 6 kg/hr. After that, the composition was dried in an air oven of 40° C. for 10 hours to remove the excessive moisture.

A mixture of 70 portions of linear low density polyethylene (LLDPE, the melting flow rate being 2 g/10 min, purchased from ExxonMobil Chemical with the commercial name of LL1002YB) and 30 portions of high density polyethylene (HDPE, the melting flow rate being 0.7 g/min, from ExxonMobil Chemical with the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min. The film formed had the following structure (total thickness 50μ):
20μ (70% LLDPE+30% HDPE)−20μ (70% LLDPE+30% LDPE)−10μ the adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, the cross head speed was set at 300 mm/min, and 180° as the peeling angle. The peeling strength at different aging times (the mean value of 5 tests) and the appearance of the surface protected were recorded. The results were listed in the table below:

| Storage | Storage Temp | Peel strength | Appearance of the |
|---|---|---|---|
| Days | (° C.) | (N/25 mm) | surface after peeling |
| 1 | 23 | 1.9 | No residue |
| 1 | 60 | 4.4 | No residue |
| 3 | 60 | 6.8 | No residue |
| 5 | 60 | 8.7 | No residue |

Test results indicated that the peeling strength after it was stored at room temperature for 1 day was 1.9 N/25 mm, while the peeling strength after aging at high temperature increased to 8.7 N/25 mm, exceeding the preferred range of the peeling strength (0.25-8.0 N/25 mm).

### Example 7

### Described in the Present Example Was the Impact of Addition of Linear Low Density Polyethylene on the Stability of the Final Peeling Strength After Aging.

In a 20-mm Brabender double screw extruder, melts of 2.5 kg of an ethylene-vinyl acetate copolymer (25 wt % of vinyl acetate, melt flow rate being 2.0 g/10 min), 2.5 kg of an ethylene-vinyl acetate copolymer (28 wt % of vinyl acetate, melt flow rate being 6.0 g/10 min), and 3.0 kg of a maleic acid grafted ethylene-vinyl acetate copolymer (28 wt % of vinyl acetate, melt flow rate being 1.4 g/10 min), 2.0 kg of the hydrogenated hydrocarbon resin tackifier (REGALITE® 1125, purchased from Eastman Chemical Company) and 10 g of the antioxidant (commercial name Anox™ 20N purchased from Chemtura) and 2.5 kg of linear low density polyethylene (0.918 in density, melt flow rate being 2.0 g/10 min) were mixed. The screw of the extruder was set in such a way that all of the components can be melted/kneaded, and appropriately dispersed. The temperature of the processing area was set at 130-190° C., and the melt temperature at 205-210° . The screw speed was 250 rpm. The feed speed was set at 6 kg/hr. After that, the composition was dried in an air oven of 40° C. for 10 hours to remove the excessive moisture.

A mixture of 70 portions of linear low density polyethylene (LLDPE, the melting flow rate being 2 g/10 min, purchased from ExxonMobil Chemical with the commercial name of LL1002YB) and 30 portions of high density polyethylene (HDPE, the melting flow rate being 0.7 g/min, from ExxonMobil Chemical with the commercial name of HTA108) was used as the polymer substrate for co-extruding and film blowing with the adhesive composition. A GEC 3-layer film blowing line (3 inch die head) was used, the temperature of the processing area was set at 130-200° C., and the line speed was 12 m/min. The film formed had the following structure (total thickness 50μ):
20μ (70% LLDPE+30% HDPE)−20μ (70% LLDPE+30% LDPE)−10μ the adhesive layer.

The protecting film was attached to the surface of an aluminum alloy plate coated with polyester coating. The panel was heated to 55° C., and the protecting film was pressed and attached to the panel using a manual rubber roller 2.5 kg by weight. 5 test samples were prepared in parallel.

The panel with the protecting film attached to it was placed at room temperature for one day, then placed in an air oven of 60° C. for a certain period of time, and then the peeling strength was tested. The peeling strength was tested using an Instron instrument, with the cross head speed being set at 300 mm/min, and 180° as the peeling angle. The peeling strength at different aging times (the mean value of 5 tests) and the appearance of the surface protected were recorded. The results were listed in the table below:

| Storage | Storage Temp | Peel strength | Appearance of the |
|---|---|---|---|
| Days | (° C.) | (N/25 mm) | surface after peeling |
| 1 | 23 | 0.7 | No residue |
| 1 | 60 | 1.3 | No residue |
| 3 | 60 | 1.4 | No residue |
| 5 | 60 | 1.5 | No residue |

Test results indicated that after 20% linear low density polyethylene was added in, the peeling strength after it was stored at room temperature for 1 day was 0.7 N/25 mm, while the peeling strength after aging at high temperature was 1.5 N/25 mm Compared with Comparative Example 3, the peeling strength after aging was controlled within the desired range of the peeling strength, which was 0.25-8.0 N/25 mm The peeling strength after aging was controlled fairly well.

Judged by the examples and comparative examples mentioned above, the adhesive composition disclosed in the present article can have more stable peeling strength, thus being applicable to the case of storage of the product to be protected for a longer term.

1. A peelable surface protecting film with a stable peeling strength, which comprises or is produced from a polymeric base layer having laminated, coated, or applied, thereon a layer of heat-activable adhesive composition wherein
the adhesive composition comprises or is produced from (a) an ethylene-vinyl acetate copolymer having a content of the moiety derived from vinyl acetate monomer of more than 15 wt % or an ethylene-C₁₋₄ alkyl (meth)acrylate copolymer; (b) an unsaturated dicarboxylic anhydride moiety-containing ethylene-vinyl acetate copolymer or an unsaturated dicarboxylic anhydride moiety-containing ethylene-C₁₋₄ alkyl (meth)acrylate copolymer; (c) 3-35 wt % of a tackifier; and (d) 4.5-30 wt % of a modifier, which is a polymer selected from the group consisting of ethylene homopolymer. ethylene-α-olefin copolymer, propylene homopolymer, propylene copolymer, ethylene-vinyl acetate copolymer having a content of the moiety derived from vinyl acetate monomer of less than 15 wt % and a mixture of two or more thereof; all % is based on the weight of the adhesive composition;
the total amount of (a) and (b) is 45-92% of the total weight of the composition, and the amount the moiety derived from the anhydride is 0.02-2%; and
the contents of —C(O)O— moiety in (a) and (b) is 7-15% of the total weight of (a) and (b).

2. The film of claim 1 wherein the amount of the modifier is 7-28 wt %, preferably 10-25 wt %, and more preferably 15-20 wt %.

3. The film of claim 1 wherein the density of the ethylene homopolymer or ethylene-α-olefin copolymer is 0.865-0.970 g/cc; and the melt flow rate thereof, according to ASTM D 1238 at 190° C., is 0.5-15 g/10 min, preferably 1-13 g/min, and more preferably 2-10 g/10 min.

4. The film of claim 1 wherein the melt flow rate of the propylene homopolymer or propylene copolymer, according to ASTM D 1238 at 230° C., is 0.5-15 g/10 min, preferably 1-13 g/10 min, and more preferably 2-10 g/10 min

5. The film of claim 1 wherein the content of the vinyl acetate in the ethylene-vinyl acetate copolymer having a content of the moiety derived from vinyl acetate monomer of less than 15% by weight is 1-15 wt %, preferably 2-12 wt %, and more preferably 3-10 wt %.

6. The film of claim 5 wherein the melt flow rate of the ethylene-vinyl acetate copolymer having a content of the moiety derived from vinyl acetate monomer of less than 15 wt %, according to ASTM D 1238 at 190° C., is 0.5-15 g/10 min, preferably 1-13 g/10 min, and more preferably 2-10 g/10 min.

7. The film of claim 1 wherein the total amount of (a) and (b) is 50-85 wt %, preferably 55-80 wt %, of the total weight of the composition.

8. The film of claim 1 wherein the amount of the moiety derived from the anhydride is 0.05-1.8 wt %, preferably 0.08-1.5 wt %, of the total weight of the composition.

9. The film of claim 1 wherein the amount of the moiety derived from vinyl acetate monomer in the ethylene-vinyl acetate copolymer having a moiety derived from vinyl acetate monomer of more than 15% is 15-45 wt %, preferably 18-40 wt %, and more preferably 20-30 wt %.

10. The film of claim 9, wherein the melt flow rate of the ethylene-vinyl acetate copolymer having a moiety derived from vinyl acetate monomer of more than 15%, according to ASTM D 1238 at 190° C., is 0.5-30 g/10 min, preferably 1-25 g/10 min, and more preferably 2-15 g/10 min.

11. The film of claim 1, wherein the tackifier is selected from the group consisting of coumarone-indene resin having a molecular weight of from 500 to 5,000, terpene resin having a molecular weight range from 600 to 6,000, butadiene-styrene resin having a molecular weight of from 500 to 5,000 and polybutadiene resin having a molecular weight ranging from 500 to 5,000.

12. The claim 1, wherein the amount of the tackifier is 3.5-30%, preferably 3.7-20%, of the total weight of the composition.

13. The film of claim 1 comprising:
40-70 wt % of an ethylene-vinyl acetate copolymer having a content of vinyl acetate monomer of more than 15 wt %;
10-25 wt % of a copolymer having moiety derived from ethylene monomer and moiety derived from vinyl acetate monomer and grafted by maleic anhydride;
the content of C(═O)O moiety thereof is 9-15 wt % of the total weight of the above components, and the amount of the moiety derived from maleic anhydride is 0.1-1% of the total weight of the composition;
3.5-16 wt % of a tackifier; and
7-25 wt % of a modifier.

14. The film of claim 1 wherein the α-olefin is selected from the group consisting of butene, hexene and/or octane, and the propylene copolymer is a propylene-ethylene copolymer.

15. The film of claim 1 wherein the polymeric base layer is formed by a polymer selected from the group consisting of low density, medium density or high density ethylene homopolymer or copolymer, propylene homopolymer or copolymer, polyester, polyamide, polyvinyl chloride, polycarbonate and a mixture of two or more thereof.

16. A protected article comprising the film of any one of claims 1 to 15 and the article is selected from the group consisting of color coated steel plate, stainless steel plate, aluminum plate, copper plate, plastic panel, treated wood, wood composite, glass and paper.

17. The article of claim 16 wherein the article is the plastic panel selected from the group consisting of methacrylic acid resin panel and polycarbonate resin panel.
